(19) United States
(12) Patent Application Publication
(10) Pub. No.: US 2012/0167360 A1
(43) Pub. Date: Jul. 5, 2012

(54) POST MORTEM SHEET AND METHOD

(76) Inventor: PHYLISS DRALLE, MORRIS, IL (US)

(21) Appl. No.: 12/984,310

(22) Filed: Jan. 4, 2011

(51) Int. Cl. A01N 1/00

(52) U.S. Cl. 27/22.1; 27/21.1

(57) ABSTRACT

A method for closing and sealing wounds and incisions in a body during transport to a funeral home, for example, from a post mortem medical facility, without the use of stitches, includes closing and sealing the wounds and/or incisions with adhesive sheets. A sheet having an adhesive disposed substantially on an inner side of the sheet is dispensed and placed over a portion of the incision with the adhesive facing a direction of the body. The sheet is then adhered to the body on both sides of the incision such that the incision is closed and sealed from leakage of fluids.

### TECHNICAL FIELD

This patent disclosure relates generally to medical devices and, more particularly to devices used in conjunction with internal post mortem examinations.

### BACKGROUND

Post mortem examinations or autopsies of human bodies are examinations that are performed for various reasons, including to determine the cause of death, the state of health of a person before death, or for academic purposes. When an autopsy is performed, a human body is received at a medical examiner's office for examination, typically in an appropriate packaging device, such as a bag. The examination of the body typically includes a physical examination and, in certain cases, one or more toxicology tests.

When undertaking a physical examination, the medical examiner may perform an external examination as well as an internal examination of the body. The internal examination is typically conducted on a specialized table and involves an inspection of the internal organs. Different types of incisions can be made to provide access to the internal organs. One type of incision is a large and deep Y-shaped incision that extends from the top of each shoulder to the lower point of the sternum and down the chest to the pubic bone. Other types of incisions include a T-shaped incision extending from the ends of both shoulders, or a vertical cut made from the middle of the neck, all vertical incisions terminating in the vicinity of the pubic bone. Additional incisions may also be made to other parts of the body for examination or to permit removal of internal organs, for example, by performing incisions around the vertebral column, cuts behind the head to permit examination of the brain and the like.

Regardless of the type of incision used to examine the internal organs, the body is reconstituted after the autopsy is complete such that it can be viewed, for example, before burial or cremation. Typically, the internal body cavity is lined with cotton or another absorbent material before the removed organs are replaced, typically contained within a bag. The chest flaps and other incisions are sewn back together, and the body is sent to a funeral home for embalming.

The stitching performed by the medical examiner to reconstitute the body is a laborious process that carries the risk of puncture by a contaminated needle. Moreover, stitching of incisions is only partially effective in avoiding the leakage of fluids from the body during transport from the medical examiner's office to the funeral home. Typically, the stitching on the body is removed and replaced by new stitching at the funeral home, which adds time and expense to the embalming process.

### SUMMARY

The disclosure describes, in one aspect, a method for closing and sealing wounds and incisions in a body, such as during transport to a funeral home. The closure and sealing can advantageously be accomplished without the use of stitches. The method includes closing and sealing the wounds and/or incisions with adhesive sheets. A sheet having an adhesive disposed substantially on an inner side of the sheet is dispensed and placed over a portion of the incision with the adhesive facing a direction of the body. The sheet is then adhered to the body on both sides of the incision such that the incision is closed and sealed from leakage of fluids.

### BRIEF DESCRIPTION OF THE DRAWINGS

FIG. 1 is a front view of a body having incisions made during a post mortem examination in accordance with the disclosure.

FIGS. 2 and 3 are front and side views, respectively, of a body having a post mortem wrap in accordance with the disclosure.

FIGS. 4 and 5 are front and side views, respectively, of a body having an alternative embodiment of a post mortem wrap in accordance with the disclosure.

FIG. 6 is a perspective view of a roll of post mortem wrap material in accordance with the disclosure.

FIG. 7 is a flowchart for a method in accordance with the disclosure.

### DETAILED DESCRIPTION

This disclosure relates to devices and methods for use in reconstituting bodies following a post mortem medical examination. In the disclosed embodiments, an adhesive sheet is used in lieu of stitches to close incisions made, for example, by a medical examiner before a funeral director can prepare the body for a funeral service. Apart from their use for closure of the incisions, the adhesive sheets disclosed herein are also well suited for sealing of the incision against leakage of fluids from the body, more so than the stitches typically used by medical examiners.

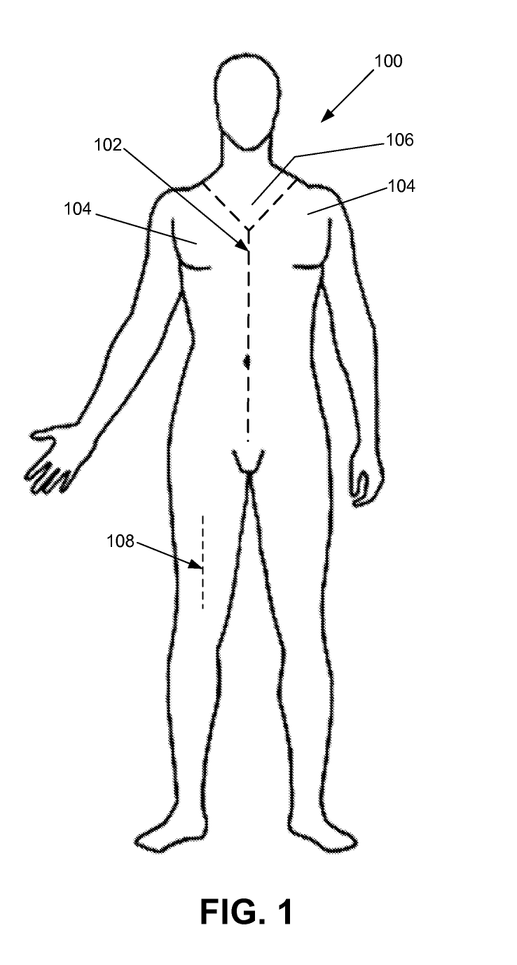

A front view of a body 100 is shown in FIG. 1 to illustrate a few of the many types of incisions that may be performed during a post mortem examination. Accordingly, the body 100 includes a Y-shaped incision 102, which is illustrated in dashed lines. The Y-shaped incision 102, which is typically used for forensic examinations, extends from the top of each shoulder to the sternum and then vertically down to the pelvic bone of the body 100. After the incision 102 has been made, two chest flaps 104 and a top flap 106 may be pulled back to reveal internal organs of the body 100 for examination. As shown in FIG. 1 and as previously described, additional incisions may be made. For example, a secondary incision 108 may be made in an appropriate area of the body 100 to permit examination of particular areas of the body 100, such as wound sites, the brain, or other areas of examination. As shown in FIG. 1, the secondary incision 108 is made to the leg, which is typically an unlikely area of examination but which is shown here to illustrate that secondary incisions are possible.

When the examination of the internal organs is complete, the body 100 is reconstituted for stable transport to a funeral home. Typically, a medical examiner or an appropriately trained technician will carefully stitch the flaps 104 and 106 back together. However, such stitching carries the risk of puncture of the technician's hand with a contaminated needle, is time consuming, and is not entirely effective at preventing leakage from fluids from the body 100. The various embodiments of the post mortem wrap disclosed herein can be used to replace this type of stitching while also reducing or eliminating fluid leakages from the body 100 before a funeral director can receive and process the body, as will be described in more detail hereinafter.

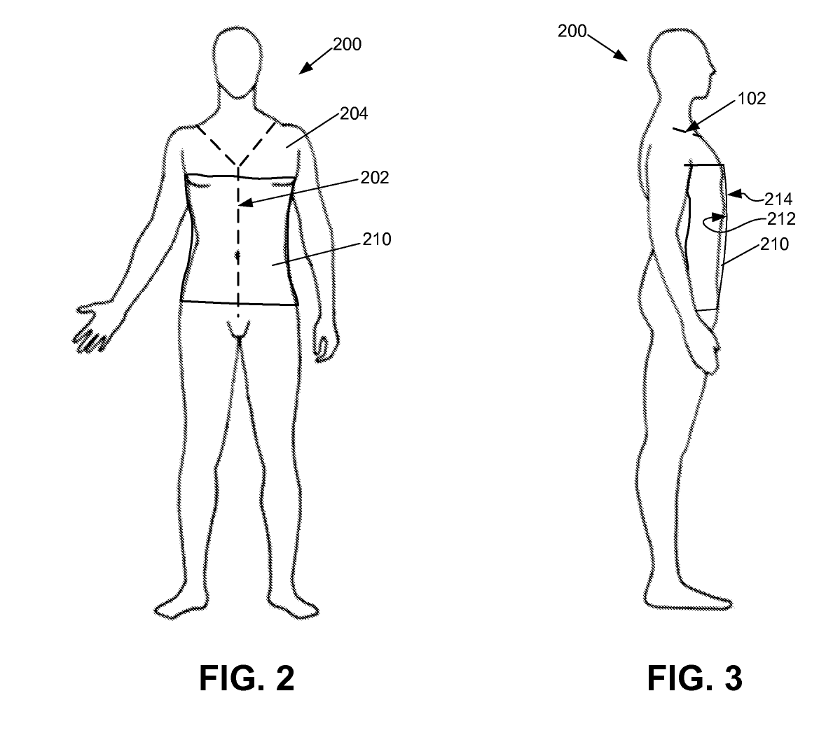

A body 200 is shown from front and side views in FIGS. 2 and 3, respectively. The body 200 includes a Y-shaped incision 202 following an internal post mortem examination as previously described. As shown, the body 200 has been closed and sealed following completion of the examination by use of a post mortem wrap sheet 210. The sheet 210 includes inner and outer faces 212 and 214, respectively. The inner face 212 is placed in contact with the body 200 and includes an adhesive substance thereon configured to adhere to the body 200. In this way, the sheet 210 is placed on the body 200 to close and seal at least a portion of the incision 202. As shown in FIGS. 2 and 3, the sheet 210 extends from below the armpits of the body to just above the pelvic bone such that the a vertical portion of the Y-shaped incision 202 is closed. More particularly, the adhesion of the sheet 210 to the chest flaps 204 is sufficient to maintain the flaps 204 in contact with one another. Moreover, the unitary structure of the sheet 210 prevents leakage of fluids from the incision 202 over areas of the body 200 that are covered by the sheet 210. In this embodiment, the sheet 210 extends at least over those portions of the incision 202 that are most likely to produce fluids that can leak.

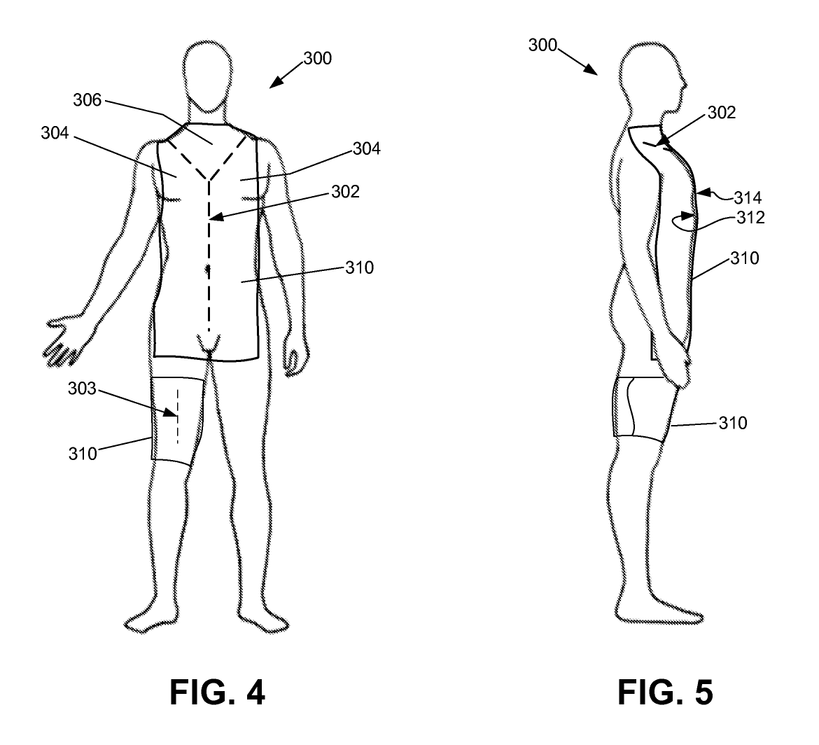

An alternative embodiment of a post mortem wrap sheet 310 is shown in FIGS. 4 and 5. In this embodiment, a body 300 includes a Y-shaped incision 302 and a secondary incision 303. As previously described, the secondary incision is shown on the leg for purpose of illustration but may be made anywhere else on the body 300. The sheet 310 in this embodiment is placed higher on the chest of the body 300 when compared to the position of the sheet 210 on the body 200 (FIG. 2), and extends up to the neck. In this way, the sheet 310 is configured to not only secure the chest flaps 304 but also the top flap 306. The secondary incision 303 is closed by an additional sheet 310, which in this position is secured to the body 300 by being wrapped around the leg. It should be appreciated that a different positioning of the secondary incision 303 and/or other incisions made to the body 300, such as in the head, may also be secured by adhering additional sheets 310 to the body 300, as shown relative to the Y-shaped incision 302, or alternatively by wrapping the sheet 310 around a portion of the body 300.

The sheets 210 or 310 may be made of a translucent material, as shown in FIGS. 2-5, or may alternatively be made of an opaque material. Suitable materials for constructing the sheets include any type of pliable sheet material that is resistant to humidity, liquids, and chemicals, such as polyethylene sheet of an appropriate thickness, for example, 6 mil. Each sheet further includes a layer of adhesive on one side thereof that is suitable for semi-permanent and liquid-tight adhesion to skin. One example of such an adhesive can be found in U.S. Pat. No. 5,906,601 (the ‘601 patent), which describes a suitable adhesive composition for use in wound dressings. The ‘601 patent was granted on May 25, 1999, is assigned on its face to the Bristol-Myers Squibb Company, and is hereby incorporated herein in its entirety by reference.

The sheets 210 or 310 may further include a removable backing material that is configured to temporarily cover the adhesive side of each sheet while the sheets are stored or transported, such that the adhesive disposed thereon is protected. The removable backing material is optional insofar as the sheets may be stacked together such that the topmost sheet can be peeled off the stack when dispensed for use. Further, the sheets 210 and 310 may be dispensed in predetermined sizes, for example, each sheet being rectangular and measuring about 24 in. by 48 in. Alternatively, the sheets 210 or 310 may be dispensed from a roll that can either permit the cutting of sheets therefrom in custom sizes or include preformed perforations to permit the selective removal of sheets.

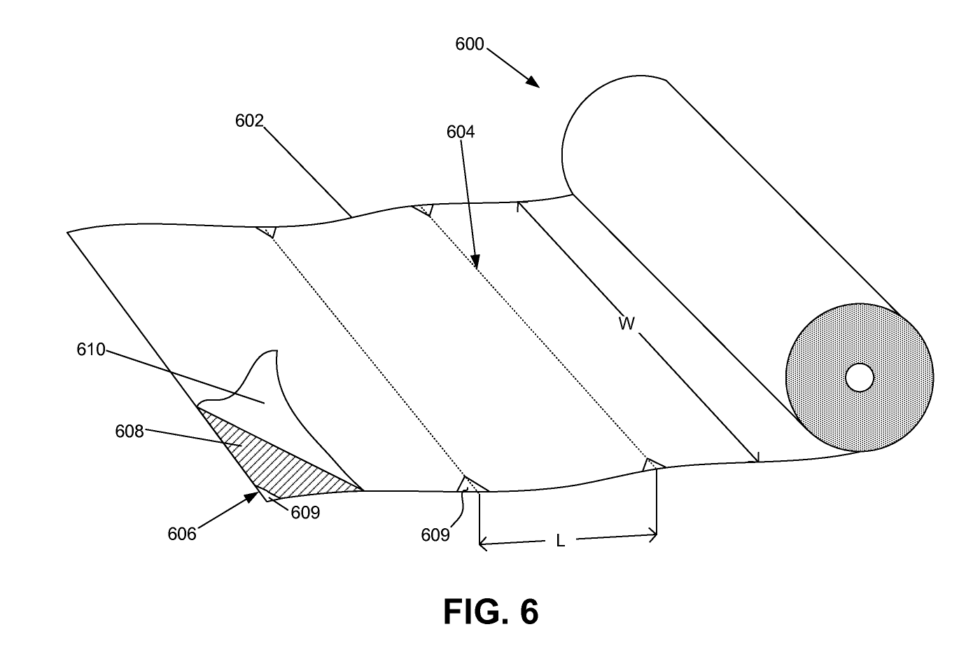

One such embodiment is shown in FIG. 6, which illustrates a roll 600 of sheets 602. The roll 600 has a width, W, of about 48 inches. The sheets 602 are consecutively arranged to form the roll 600 and include perforations 604 that are configured to permit the user to dispense one or more sheets 602 at any one time. The perforations 604 are spaced a distance, L, of about 24 inches along the length of the roll 600. Each sheet 602 is made of a three-layer construction. A base layer 606 constitutes the useable sheet and may be made of a polyethylene sheet having a thickness of about 6 mil. A layer of adhesive 608 is disposed along a substantial portion of what will be the inner surface of the sheet 602 during use. Optionally, portions 609 of the base layer 606 close to the corners of each sheet 602 may be left uncovered by the adhesive layer 608 to facilitate the removal of a backing layer 610 therefrom. The backing layer 610 is optional and is disposed over the adhesive layer 608 to protect it from contamination and to facilitate the unrolling of the roll 600.

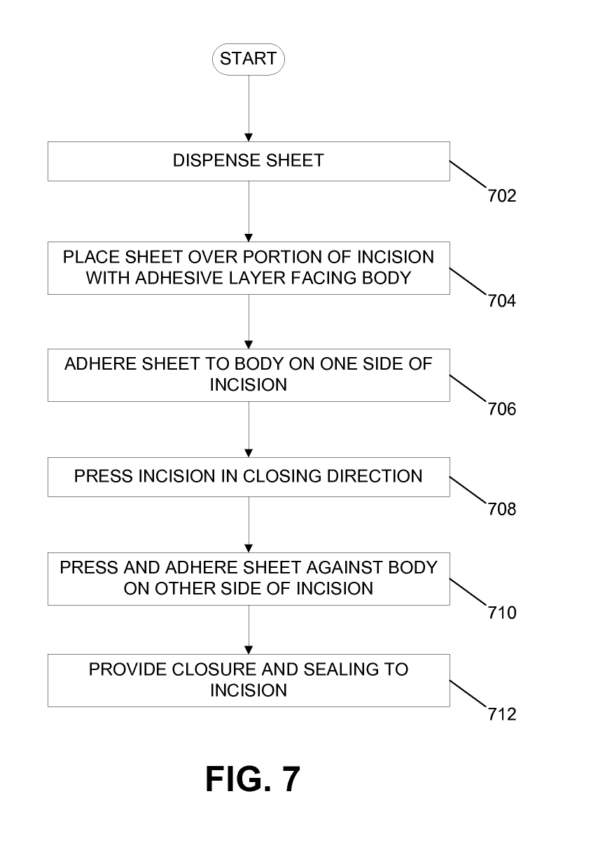

A flowchart for a method of using sheets to close and/or seal incisions following a post mortem examination is shown in FIG. 7. After the examination has been completed and, optionally, a body has been appropriately reconstituted by a medical examiner, coroner, or the like, a sheet having an adhesive layer disposed substantially over one side thereof is dispensed at process step 702. The sheet may be dispensed from a stack of sheets or cut at an appropriate size from a roll. The sheet is placed over a portion of incision with the adhesive layer facing the body at process step 704. If the sheet includes a backing layer, the backing layer may be removed to expose the adhesive before or while the sheet is placed over the body. With the adhesive layer exposed, the sheet is pressed against the body on at least one side of the incision adheres to the body at process step 706. The incision is pressed in a closing direction at process step 708, and the sheet is pressed and adhered against the other side of the incision at process step 710. Thereafter, the adhered sheet provides closure and sealing to the portion of the incision disposed under the sheet at process step 712. The process may further include additional process steps following the transport of the body with the sheet disposed thereon to a funeral home. For example, a funeral director may remove the sheet for gaining access to the incision during an embalming process.

As can be appreciated, the application of the disclosed post mortem sheets are not limited to the closure and sealing of incisions resulting from internal post mortem medical examinations, but have a multitude of other uses. For example, sheets in accordance with the present disclosure may be used to close and seal severely injured and/or disfigured parts of bodies, or to simply close and seal open wounds during transport to a morgue or other post mortem medical facility to avoid the risk of contamination of personnel or of the body itself. Moreover, sheets in accordance with the present disclosure may be used in the field to preserve the condition of a body for subsequent forensic investigation.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

I claim:

1. A method for closing and sealing an incision in a body after a post mortem examination without use of stitches to close the incision, comprising:
dispensing a sheet having an adhesive disposed substantially on an inner side of the sheet;
placing the sheet over a portion of the incision with the adhesive facing a direction of the body; and
adhering the sheet to the body on both sides of the incision such that the incision is closed and sealed from leakage of fluids.

2. The method of claim 1, further comprising removing a protecting layer from the sheet to expose the adhesive prior to placement of the sheet on the body.

3. The method of claim 1, wherein dispensing the sheet includes peeling the sheet from a topmost layer of a stack of sheets.

4. The method of claim 1, wherein dispensing the sheet includes dispensing a desired length of sheet from a roll and cutting the desired length.

5. The method of claim 1, wherein adhering the sheet to the body on both sides of the incision includes adhering the sheet on one side of the incision, pressing the incision in a closing direction, and then adhering the sheet on a second side of the incision.

6. The method of claim 1, wherein adhering the sheet to the body on both sides of the incision includes wrapping the sheet around a portion of the body.

7. The method of claim 1, further comprising removing the sheet from the body as part of an embalming process.

8. A method for preparing a body for transport from a post mortem medical examination facility to a funeral home, comprising:
performing an incision in the body as part of an internal post mortem medical examination;
dispensing a sheet having an adhesive disposed substantially on an inner side of the sheet;
placing the sheet over a portion of the incision with the adhesive facing a direction of the body; and
adhering the sheet to the body on both sides of the incision such that the incision is closed and sealed from leakage of fluids.

9. The method of claim 8, further comprising removing a protecting layer from the sheet to expose the adhesive prior to placement of the sheet on the body.

10. The method of claim 8, wherein dispensing the sheet includes peeling the sheet from a topmost layer of a stack of sheets.

11. The method of claim 8, wherein dispensing the sheet includes dispensing a desired length of sheet from a roll and cutting the desired length.

12. The method of claim 8, wherein adhering the sheet to the body on both sides of the incision includes adhering the sheet on one side of the incision, pressing the incision in a closing direction, and then adhering the sheet on a second side of the incision.

13. The method of claim 8, wherein adhering the sheet to the body on both sides of the incision includes wrapping the sheet around a portion of the body.

14. The method of claim 8, further comprising removing the sheet from the body as part of an embalming process that is conducted at the funeral home.
